(19) United States
(12) Patent Application Publication
(10) Pub. No.: US 2025/0360785 A1
(43) Pub. Date: Nov. 27, 2025

(54) SUPPORT STRUCTURE AND SUPPORT METHOD OF RECIRCULATION PIPE

(71) Applicant: MAZDA MOTOR CORPORATION, Hiroshima (JP)

(72) Inventor: Tsuyoshi FURUNO, Aki-gun (JP)

(73) Assignee: MAZDA MOTOR CORPORATION, Hiroshima (JP)

(21) Appl. No.: 19/096,179

(22) Filed: Mar. 31, 2025

(30) Foreign Application Priority Data
May 24, 2024 (JP) 2024-084797

(51) Int. Cl. B60K 15/04; B60R 16/08

(52) U.S. Cl. CPC B60K 15/04; B60R 16/08

(57) ABSTRACT

A recirculation pipe connecting an upper space of an inside of a tank and a side of a fuel-supply port of the fuel pipe is configured such that a tank-side pipe thereof located on a side of the tank and a fuel-supply-port-side pipe thereof located on a side of the fuel-supply port are connectable, the fuel-supply-port-side pipe is arranged in the vicinity of a bent portion of the fuel pipe such that the fuel-supply-port-side pipe is pushed toward the bent portion by the tank-side pipe when the both pipes are connected, and a spacer is provided between the bent portion and the fuel-supply-port-side pipe in a state where the spacer contacts the bent portion and the fuel-supply-port-side pipe, respectively. The spacer includes a fuel-supply-port-side-pipe contact face which is curved in a recess shape relative to the fuel-supply-port-side pipe such that the pushed fuel-supply-port-side pipe is contactable.

### BACKGROUND OF THE INVENTION

The present invention relates to a support structure and a support method, in which a fuel pipe connecting an inside of a tank and a fuel-supply port and a recirculation pipe connecting an upper space of the inside of the tank and a side of the fuel-supply port of the fuel pipe are provided and the recirculation pipe is supported by the fuel pipe provided on a vehicle-body side when being assembled to the vehicle-body side.

The recirculation pipe is configured such that a tank-side pipe thereof which is located on a tank side and a fuel-supply-port-side pipe thereof which is located on a fuel-supply-port side are connectable. The tank-side pipe and the fuel-supply-port-side pipe are connected to each other when the recirculation pipe is assembled to a vehicle body.

Herein, when the tank-side pipe and the fuel-supply-port-side pipe are connected to each other, this connection is conducted by pushing a connection end portion of the tank-side pipe to a connection end portion of the fuel-supply-port-side pipe. Herein, in a case where there occurs rattling due to this pushing, a smooth connection may be difficult and an improper load may be applied to the fuel-supply-port-side pipe.

Accordingly, as exemplified in the patent document of WO2017/222031, it may be effective that the recirculation pipe is fixed at the fuel pipe arranged nearby by using a bracket so that when the fuel-supply-port-side pipe is connected to the tank-side pipe, the proper support can be attained without the above-described rattling.

However, since a bent portion of the fuel pipe tends to have variation in dimension compared to its straight portion due to processing error, in a case where the fuel-supply-port-side pipe arranged near the bent portion of the fuel pipe is fixed to this bent portion, a gap between the bent portion and the fuel-supply-port-side pipe tends to vary. Under this situation, if the fuel-supply-port-side pipe is fixed to the bent portion compulsorily, neglecting the above-described variation, there is a concern that the improper load may be applied to the fuel-supply-port-side pipe. Thus, some effective countermeasures become necessary.

Herein, the above-described patent document merely discloses the structure in which when the recirculation pipe is fixed to the fuel pipe, the respective straight portions are fixed by using the bracket. The patent document fails to disclose any fixation of the recirculation pipe to the bent portion of the fuel pipe and any problem caused by the fixation.

### SUMMARY OF THE INVENTION

The present invention has been devised in view of the above-described problem, and an object of the present invention is to provide a support structure and a support method of the recirculation pipe which can properly attain the smooth connection work (operation) of the fuel-supply-port-side pipe and the tank-side pipe, suppressing any improper load applied to the fuel-supply-port-side pipe, even if the gap variation occurs between the bent portion of the fuel pipe and the fuel-supply-port-side pipe of the recirculation pipe.

The support structure of a recirculation pipe of the present invention comprises a fuel pipe connecting an inside of a tank and a fuel-supply port and including a bent portion and a recirculation pipe connecting an upper space of the inside of the tank and a side of the fuel-supply port of the fuel pipe, the recirculation pipe being configured such that a tank-side pipe thereof which is located on a side of the tank and a fuel-supply-port-side pipe thereof which is located on a side of the fuel-supply port are connectable, wherein the fuel-supply-port-side pipe of the recirculation pipe is arranged in the vicinity of the bent portion of the fuel pipe such that the fuel-supply-port-side pipe is pushed toward the bent portion by the tank-side pipe when the tank-side pipe and the fuel-supply-port-side pipe are connected, and a spacer is provided between the bent portion of the fuel pipe and the fuel-supply-port-side pipe of the recirculation pipe in a state where the spacer contacts the bent portion and the fuel-supply-port-side pipe, respectively, the spacer including a fuel-supply-port-side-pipe contact face which is curved in a recess shape relative to the fuel-supply-port-side pipe such that the pushed fuel-supply-port-side pipe is contactable.

According to the present invention, while the gap between the recirculation pipe and the bent portion of the fuel pipe tends to vary in a vehicle assembling when the tank-side pipe and the fuel-supply-port-side pipe are connected in the structure in which the fuel-supply-port-side pipe is arranged at the position where the fuel-supply-port-side pipe is pushed toward the bent portion by the tank-side pipe, the curve-shaped fuel-supply-port-side-pipe contact face can be made to properly contact the fuel-supply-port-side pipe of the recirculation pipe by adjusting the position of the spacer along the bent portion.

Accordingly, when the tank-side pipe and the fuel-supply-port-side pipe are connected, the load applied to the fuel-supply-port-side pipe can be suppressed by the spacer and also the position of the fuel-supply-port-side pipe relative to its pushing direction can be controlled, so that the smooth connection work can be attained.

In an embodiment of the present invention, the fuel-supply-port-side-pipe contact face of the spacer may be configured to be parallel to an arrangement direction of the fuel-supply-port-side pipe of the recirculation pipe which contacts the fuel-supply-port-side-pipe contact face.

According to this embodiment, even if the fuel-supply-port-side pipe is pushed toward the bent portion by the tank-side pipe when the fuel-supply-port-side pipe and the tank-side pipe are connected, the fuel-supply-port-side pipe can be made to properly contact the fuel-supply-port-side-pipe contact face along the arrangement direction. Thereby, the fuel-supply-port-side-pipe contact face can support the fuel-supply-port-side pipe stably.

In another embodiment of the present invention, the fuel-supply-port-side-pipe contact face of the spacer may be configured to have a smaller curvature than the bent portion of the fuel pipe.

According to this structure, the fuel-supply-port-side-pipe contact face can be formed in a wedge shape such that the distance from the bent portion is narrower as it goes close to the fuel-supply-port-side pipe in a direction along the bent portion and it enters into a gap between the bent portion and the fuel-supply-port-side pipe.

Thereby, when the spacer is made to be close to the side of the fuel-supply-port-side pipe along the bent portion, the fuel-supply-port-side-pipe contact face can be made to contact the fuel-supply-port-side pipe properly by using the wedge effect. Accordingly, when the tank-side pipe and the fuel-supply-port-side pipe are connected, the fuel-supply-port-side pipe pushed toward the bent portion contacts the spacer, so that the fuel-supply-port-side pipe can be properly supported at the bent portion via the spacer.

In another embodiment of the present invention, a circular orbit along the fuel-supply-port-side-pipe contact face of the spacer may be configured to be inscribed in a circular orbit along the bent portion at a position which is located on a side of the fuel-supply-port-side pipe relative to the spacer.

According to this structure, since the above-described wedge shape can be obtained further, the fuel-supply-port-side pipe can be further properly supported at the bent portion via the spacer when the tank-side pipe and the fuel-supply-port-side pipe are connected,

In another embodiment of the present invention, a fixation member to fix the spacer to the bent portion of the fuel pipe may be provided at a portion of the spacer which is positioned at any one side, in a direction along the bent portion, of the spacer relative to the fuel-supply-port-side-pipe contact face.

The above-described fixation member can adopt any member, such as a binding band, a double-sided tape, a face fastener, a string-shaped member, a fastening member, a welding portion, an adhesive, or any combined-structure as long as the spacer can be fixed to the bent portion.

According to this structure, when the tank-side pipe and the fuel-supply-port-side pipe are connected, the spacer can be fixed to the bent portion by the fixation member so that the fuel-supply-port-side pipe does not rattle as the tank-side pipe is pushed toward the fuel-supply-port-side pipe. That is, the fuel-supply-port-side pipe can be properly supported at the bent portion via the spacer.

Further, another aspect of the present invention is the support method of the recirculation pipe, which comprises a fuel pipe connecting an inside of a tank and a fuel-supply port and including a bent portion, a recirculation pipe connecting an upper space of the inside of the tank and a side of the fuel-supply port of the fuel pipe, the recirculation pipe being configured such that a tank-side pipe thereof which is located on a side of the tank and a fuel-supply-port-side pipe thereof which is located on a side of the fuel-supply port are connectable, and a spacer including a fuel-supply-port-side-pipe contact face which contacts the fuel-supply-port-side pipe of the recirculation pipe in a connection state of the tank-side pipe and the fuel-supply-port-side pipe, wherein the fuel-supply-port-side pipe which is pushed toward the bent portion of the fuel pipe by the tank-side pipe is configured to be supported by the fuel pipe via the spacer in a case where the tank-side pipe is connected, the support method of the recirculation pipe comprising a spacer-arrangement step of arranging the spacer between the bent portion of the fuel pipe and the fuel-supply-port-side pipe of the recirculation pipe in a state where the spacer contacts the bent portion, a spacer-position-specification step of sliding the spacer along the bent portion to a position where the fuel-supply-port-side-pipe contact face of the spacer comes to contact the fuel-supply-port-side pipe, and a spacer-fixation step of fixing the spacer at the position specified in the spacer-position-specification step.

According to this aspect of the present invention, even if the gap between the bent portion and the fuel-supply-port-side pipe varies, the spacer can be fixed in a state where it contacts these members properly. Thereby, even if the fuel-supply-port-side pipe is pushed toward the bend portion by the tank-side pipe when the fuel-supply-port-side pipe is connected to the tank-side pipe, the fuel-supply-port-side pipe can be supported properly without rattling.

As described above, the present invention can provide the support structure and the support method of the recirculation pipe which can properly attain the smooth connection work (operation) of the fuel-supply-port-side pipe and the tank-side pipe, suppressing any improper load applied to the fuel-supply-port-side pipe, even if the gap variation occurs between the bent portion of the fuel pipe and the fuel-supply-port-side pipe of the recirculation pipe.

The present invention will become apparent from the following description which refers to the accompanying drawings.

### BRIEF DESCRIPTION OF THE DRAWINGS

FIG. 1 is a perspective view of a support structure of a recirculation pipe of the present embodiment, when viewed from a vehicle-inward and upper-rear side.

FIG. 2 is an enlarged view of an area X of FIG. 1, when viewed from a forward side.

FIG. 3 is an enlarged view of a main part of the support structure of the recirculation pipe of the present embodiment, when viewed from a pushing direction in which a tank-side pipe is pushed to a fuel-supply-port-side pipe.

FIG. 4 is an enlarged view of a main part of FIG. 3.

FIG. 5 is a perspective view of a spacer of the present embodiment in a state where it is shown in FIG. 2.

FIG. 6 is a perspective view of the spacer of the present embodiment, when viewed from a vehicle-inward and upper-front side.

FIGS. 7A and 7B are explanatory diagrams of a support method of the recirculation pipe: FIG. 7A showing a spacer-arrangement step; FIG. 7B showing a spacer-position-specification step.

FIGS. 8A and 8B are explanatory diagrams of the support method of the recirculation pipe: FIG. 8A showing a completion state of the spacer-position-specification step; FIG. 8B showing a completion state of a spacer-fixation step.

### DETAILED DESCRIPTION OF THE INVENTION

Hereafter, an embodiment of the present invention will be described referring to the drawings. In figures, an arrow R shows a vehicle rear (rearward) side, an arrow U shows a vehicle upper (upward) side, and an arrow IN shows a vehicle-inward side (an inward side, in a vehicle width direction, of a vehicle body) (i.e., a cabin side or a vehicle right side in the present figures).

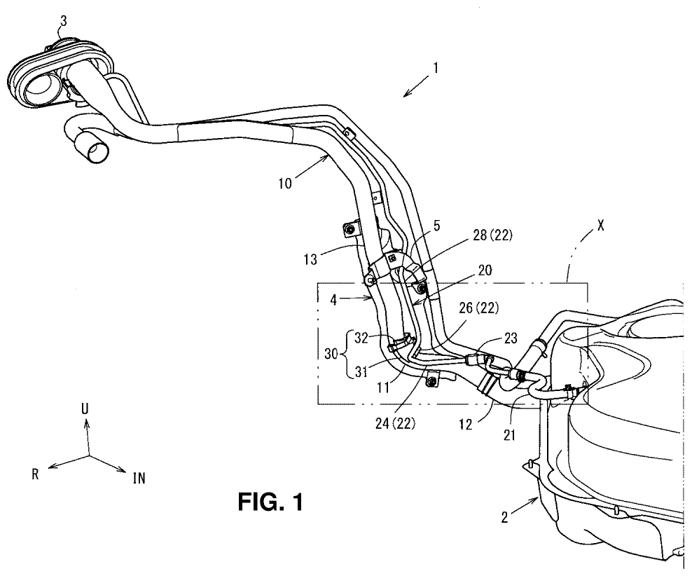

As shown in FIG. 1, a support structure 1 of a recirculation pipe 20 of the present embodiment is provided at an automobile as a vehicle, and supports the recirculation pipe 20 at a fuel pipe 10 provided on a vehicle-body side.

As shown in FIGS. 1-4, the fuel pipe 10 connects a fuel tank 2 and a fuel-supply port 3 through which fuel is supplied for the fuel tank 2. The fuel tank 2 is provided below a rear floor panel (not illustrated) which forms a rear floor face of the automobile, and is attached to cross members (not illustrated) which extend in the vehicle width direction at its front-and-rear sides.

The fuel-supply port 3 is configured such that the fuel can be poured therethrough when a fuel lid (not illustrated) is open, and arranged inside a fuel box (not illustrated) which is positioned in a rear fender panel (not illustrated) provided on a vehicle-left side. That is, the fuel-supply port 3 is provided on a vehicle-outward and upper side of the fuel tank 2.

The above-described fuel pipe 10 has a bent portion 11 at a portion thereof which is located at a midway position between the fuel-supply port 3 and the fuel tank 2 and also closer to the fuel tank 2 than the fuel-supply port 3. In the present embodiment, as shown in FIG. 1, a vehicle-width-direction arrangement portion 12 is provided at a portion of the fuel pipe 10 which is located closer to the fuel tank 2 than the bent portion 11. This vehicle-width-direction arrangement portion 12 extends roughly outward, in the vehicle width direction, of the vehicle body from the fuel tank 2. Further, a vertical-direction arrangement portion 13, which rises upward from an outer end, in the vehicle width direction, of the vehicle-width-direction arrangement portion 12 via the bent portion 11, is provided at a portion of the fuel pipe 10 which is located closer to the fuel-supply port 3 than the bent portion 11. The vertical-direction arrangement portion 13 is configured to change its extension direction to the vertical direction via the bent portion 11 with a bending angle of about 90 degrees relative to the vehicle-width-direction arrangement portion 12 which extends substantially horizontally in a vehicle rear view.

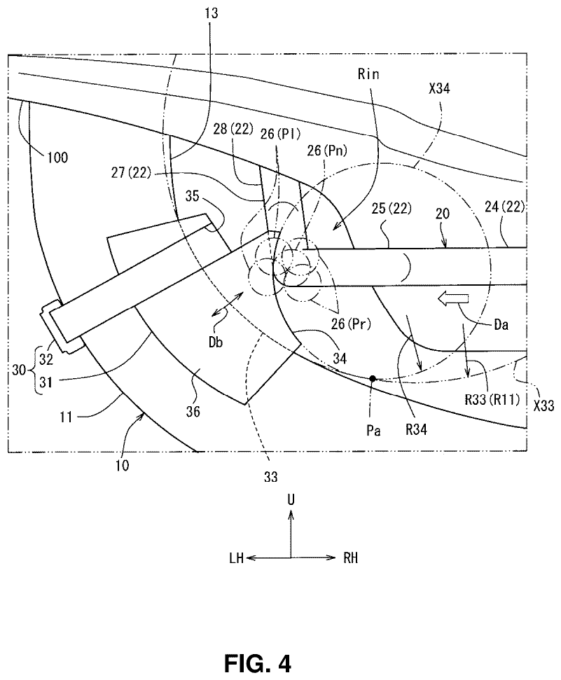

The fuel pipe 10 is a steel-made member except the portion of the vehicle-width-direction arrangement portion 12 which is located closer to the fuel tank 2. Herein, a protector 4 to protect the fuel pipe 10 is provided around a portion of the fuel pipe 10, including the bent portion 11, which is located on the outward side, in the vehicle width direction, of the vertical-direction arrangement portion 13 and on the downward side of the vehicle-width-direction arrangement portion 12. The protector 4 is attached to a surrounding vehicle-body frame (e.g., see a vehicle-body frame 100 in FIG. 4).

The recirculation pipe 20 is a pipe to exhaust vapor gas generated inside the fuel tank 2 by ventilating an upper space above a fuel level of the fuel tank 2 when the fuel is poured. The recirculation pipe 20 connects the upper space of the fuel tank 2 and a portion of the fuel box around the fuel-supply port 3 of the fuel pipe 10, and is arranged such that it extends along the fuel pipe 10.

The recirculation pipe 20 is basically divided into a tank-side pipe 21 which is made of a rubber tube and located closer to the fuel tank 2 and a fuel-supply-port-side pipe 22 which is made from steel and located closer to the fuel-supply port 3. These pipes 21, 22 are connected to each other by a coupler connector as a connection portion 23.

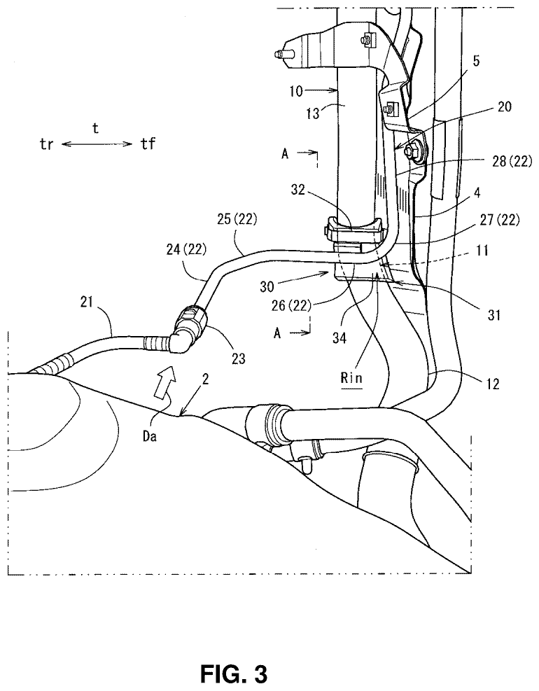

The connection portion 23 is arranged between the fuel tank 2 and the bent portion 11 of the fuel pipe 10 in the vehicle width direction. The recirculation pipe 20 is connected at the connection portion 23 such that a connection end portion of the tank-side pipe 21 which is positioned at an outward end portion, in the vehicle width direction, thereof is pushed into a connection end portion of the fuel-supply-port-side pipe 22 which is positioned at an inward end portion (lower end portion), in the vehicle width direction, thereof. Herein, the above-described pushing direction is the vehicle outward direction, i.e., a direction along a pushing-direction arrangement portion 24, which will be described later, as shown by a white arrow Da in FIG. 3. Hereafter, this direction will be referred to as the “pushing direction Da.”

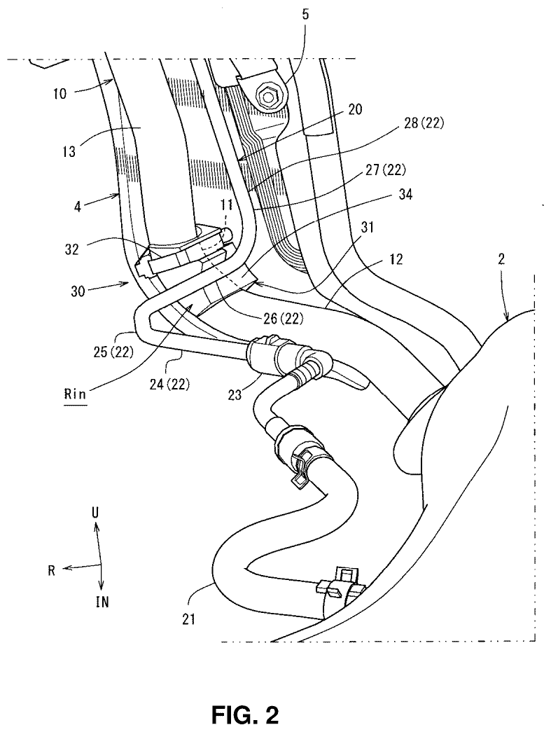

As shown in FIGS. 2 and 3, the fuel-supply-port-side pipe 22 of the recirculation pipe 20 comprises the pushing-direction arrangement portion 24 which extends in the pushing direction Da from an inward end portion, in the vehicle width direction, thereof, a longitudinal-direction arrangement portion 26 which extends forward from an outward end portion, in the vehicle width direction, of the pushing-direction arrangement portion 24 via a rear-side bent portion 25, and a vertical-direction arrangement portion 28 which extends upward from a front end portion of the longitudinal-direction arrangement portion 26 via a front-side bent portion 27. Herein, the rear-side bent portion 25 is positioned in back of and close to the bent portion 11 of the fuel pipe 10, and the front-side bent portion 27 is positioned in front of and close to the bent portion 11 of the fuel pipe 10.

The recirculation pipe 20 is arranged substantially horizontally such that the pushing-direction arrangement portion 24, the rear-side bent portion 25 and the longitudinal-direction arrangement portion 26 of the fuel-supply-port-side pipe 22, and the tank-side pipe 21 are located substantially at the same level as the bent portion 11 of the fuel pipe 10.

The fuel-supply-port-side pipe 22 is arranged as shown in FIG. 2 such that the pushing-direction arrangement portion 24 extends along the vehicle-width-direction arrangement portion 12 of the fuel pipe 10 at a rear side of and near this arrangement portion 12 and also the vertical-direction arrangement portion 28 extends along the vertical-direction arrangement portion 13 of the fuel pipe 10 at a front side of and near this arrangement portion 13.

Meanwhile, as shown in FIGS. 2-4, the longitudinal-direction arrangement portion 26 of the fuel-supply-port-side pipe 22 is arranged in an area Rin, i.e., the vehicle-width-direction inside-vicinity area Rin, which is located on an inner-angle side (diameter inner side) of and near the bent portion 11 so that it can be pushed toward the bent portion 11 by the tank-side pipe 21 when the fuel-supply-port-side pipe 22 and the tank-side pipe 21 are connected.

Further, the longitudinal-direction arrangement portion 26 of the fuel-supply-port-side pipe 22 extends in the longitudinal direction so as to be perpendicular to the bent portion 11 extending in the vertical direction and in the vehicle width direction. In the present embodiment, the longitudinal-direction arrangement portion 26 is arranged roughly horizontally.

Further, as shown in FIGS. 1 and 3, the support structure 1 of the recirculation pipe 20 of the present embodiment comprises a bracket 5 to attach the recirculation pipe 20, together with the fuel pipe 10, to the vehicle-body-side protector 4. Specifically, the bracket 5 holds these such that the recirculation pipe 20 and the fuel pipe 10 are interposed between the bracket 5 and the protector 4, and fixedly fasten these to the protector 4 by using bolts and nuts.

The bracket 5 is provided such that the fuel pipe 10 and the recirculation pipe 20 keep a specified distance therebetween at their respective portions extending roughly straightly together, specifically, the respective midway portions of their vertical-direction arrangement portions 13, 28 in the present embodiment. Herein, the recirculation pipe 20 is attached to the vehicle-body side including the fuel pipe 10 by using other brackets which are disposed at intervals in the arrangement direction, detailed description of which is omitted here.

The support structure 1 of the recirculation pipe 20 of the present embodiment further comprises a spacer 30 to fix the recirculation pipe 20 to the bent portion 11 of the fuel pipe 10 mainly. The spacer 30, which is a spacer with fixing means, comprises a spacer member 31 which corresponds to a body portion of the spacer 30 and a well-known fastening band 32 which attaches the spacer member 31 to the vehicle-body-side fuel pipe 10.

The spacer member 31 is a single member which is made from synthetic resin and formed in a three-dimensional shape, and is disposed between the bent portion 11 of the fuel pipe 10 and the fuel-supply-port-side pipe 22 of the recirculation pipe 20, specifically between the bent portion 11 and the longitudinal-direction arrangement portion 26 arranged in the inner-angle-side vicinity area Rin in the present embodiment. As described later, the spacer member 31 is fixedly fastened to the bent portion 11 of the fuel pipe 10 by the fastening band 32 in this state. In this fixation state, the spacer member 31 contacts the bent portion 11 and the fuel-supply-port-side pipe 22, respectively.

While the spacer member 31 may be made from any other material than the synthetic resin, such as the metal, the resin material is preferable from a merchant-quality perspective because the resin is the different material from the metal of the fuel pipe 10 and the fuel-supply-port-side pipe 22 and therefore rusting at respective contact portions of these members can be properly suppressed.

Hereafter, the spacer member 31 will be further described based on its position (state) where the spacer member 31 contacts the bent portion 11 and the longitudinal-direction arrangement portion 26 between the bent portion 11 and the fuel-supply-port-side pipe 22 as shown in FIG. 4 which is a view from an arrow A in FIG. 3. Herein, a perpendicular direction to the paper of FIG. 4 is set as a thickness direction t of the spacer member 31. Further, as shown in FIG. 3, one side of the thickness direction t where the vertical-direction arrangement portion 28 is provided (i.e., a back side of the paper in FIG. 4) is set as a thickness-direction one side tf, and the other side where the pushing-direction arrangement portion 24 is provided (i.e., a front side of the paper in FIG. 4) is set as a thickness-direction other side tr. In FIG. 4, an arrow RH shows a right side, an arrow LH shows a left side, and an arrow Db shows a radial direction of the bent portion 11.

As shown in FIGS. 4-6, the spacer member 31 comprises a bent-portion contact face 33, a fuel-supply-port-side-pipe contact face 34, and a band attachment portion 35. The bent-portion contact face 33 is provided at a portion of the spacer member 31 which faces the bent portion 11 in a state where the spacer member 31 is disposed between the bent portion 11 and the fuel-supply-port-side pipe 22, and this contact face 33 is formed in a cured shape along the bent portion 11. Specifically, the bent-portion contact face 33 is formed in a convex shape toward the bent side so that it is contactable with an outer face of an inner side (inner-edge side), in the radial direction, of the bent portion 11, and is formed in the curved shape along the bent portion 11.

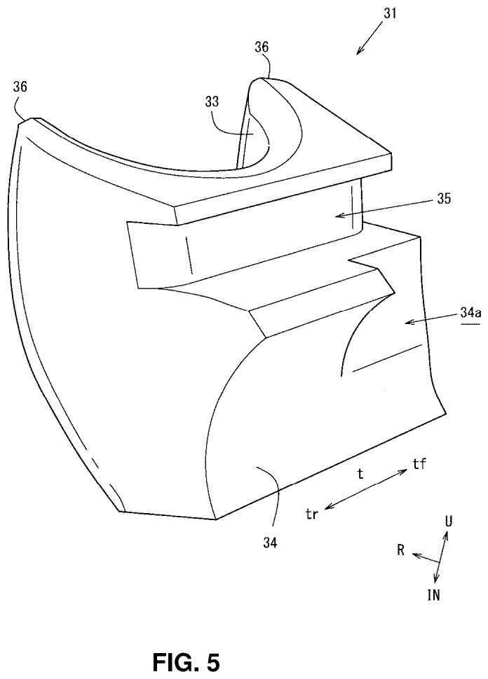

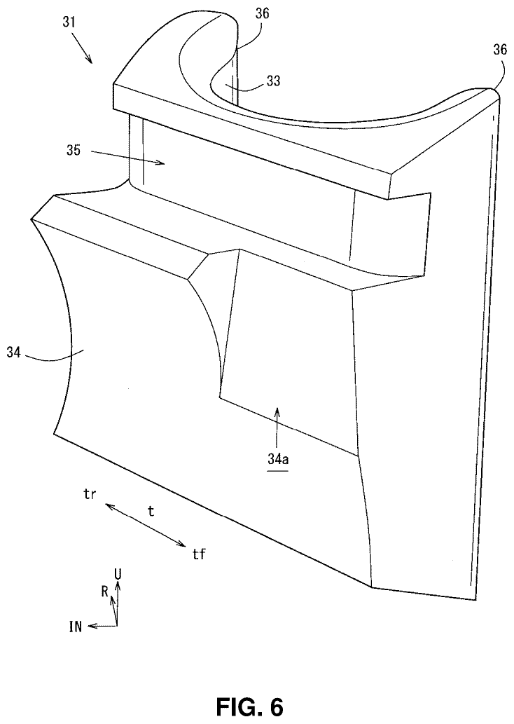

Further, as shown in FIG. 4, the bent-portion contact face 33 is formed in an arc shape such that it has the curvature R33 which is substantially the same as the curvature R11 of the bent portion 11, whereby the bent-portion contact face 33 is contactable with the bent portion 11. Moreover, as shown in FIGS. 5 and 6, the bent-portion contact face 33 is configured such that its cross section perpendicular to the direction along the bent portion 11 has a side wall portion 36 whose both sides, in the thickness direction t, relative to its center protrude toward the side of the bent portion 11 (toward the outside, in the radial direction, thereof), and the bent-portion contact face 33 is formed in a recess (concave) shape so that it can fit in the radial-direction inside portion of the bent portion 11. Thereby, as shown in FIG. 4, in the state where the bent-portion contact face 33 is made to contact the bent portion 11, the bent portion 11 is contactable in the state where its radial-direction inside portion fits in the bent-portion contact face 33.

As shown in FIG. 4, the fuel-supply-port-side-pipe contact face 34 is provided at a portion which faces the fuel-supply-port-side pipe 22 (specifically, the longitudinal-direction arrangement portion 26) in a state where the spacer member 31 is disposed between the bent portion 11 and the fuel-supply-port-side pipe 22, and the fuel-supply-port-side-pipe contact face 34 is formed in a recess (concave) shape relative to the fuel-supply-port-side pipe 22. Further, as shown in FIG. 4, the fuel-supply-port-side-pipe contact face 34 is formed in the curved shape such that it has the curvature R34 which is smaller than the curvature R33 (i.e., the curvature R11 of the bent portion 11) of the bent-portion contact face 33, whereby the fuel-supply-port-side-pipe contact face 34 is contactable with the longitudinal-direction arrangement portion 26 (see FIG. 3) of the fuel-supply-port-side pipe 22 which is provided to extent in the same direction as the thickness direction t. Herein, the curvature R34 of the fuel-supply-port-side-pipe contact face 34 is set to be larger than that of the perpendicular-cross section of the longitudinal-direction arrangement portion 26 of the fuel-supply-port-side pipe 22.

Herein, the curved shape of the fuel-supply-port-side-pipe contact face 34 is properly set, considering the gap variation between the bent portion 11 of the fuel pipe 10 and the fuel-supply-port-side pipe 22 of the recirculation pipe 20. Herein, according to the dimension variation of the bent portion 11 of the fuel pipe 10, the gap between the bent portion 11 and the longitudinal-direction arrangement portion 26 of the fuel-supply-port-side pipe 22, i.e., the position of the longitudinal-direction arrangement portion 26 relative to the bent portion 11 tends to vary easily as shown in FIG. 4. As shown by an imaginary line in FIG. 4, the longitudinal-direction arrangement portion 26 takes a right-side variation position (Pr) and the left-side variation position (Pl) relative to its nominal position (Pn). This position variation of the longitudinal-direction arrangement portion 26 relative to the bent portion 11 may be about the maximum 4 mm for each of the left side and the right side, for example.

Further, FIG. 4 shows respective variation positions, in the lateral direction and in the vertical direction, of the longitudinal-direction arrangement portion 26 relative to the nominal position (Pn) as well. As shown in FIG. 4, the fuel-supply-port-side-pipe contact face 34 is formed in the curved shape with the enough size (vertical width) to make it contact the longitudinal-direction arrangement portion 26 properly even if the position of the longitudinal-direction arrangement portion 26 relative to the nominal position (Pn) varies.

As shown in FIGS. 5 and 6, at a corner portion of the fuel-supply-port-side-pipe contact face 34 which is positioned on the one side (tf), in the thickness direction t, thereof and upper side thereof is formed an escape (interference avoidance) portion 34a which is formed in a recess shape relative to the fuel-supply-port-side-pipe contact face 34. This escape portion 34a is configured to avoid any interference of the front-side bent portion 27 with the fuel-supply-port-side-pipe contact face 34 even in a state where the spacer member 31 is arranged near the front-side bent portion 27 of the fuel-supply-port-side pipe 22 and the longitudinal-direction arrangement portion 26 of the fuel-supply-port-side pipe 22 contacts the fuel-supply-port-side-pipe contact face 34.

Moreover, as shown in FIGS. 3, 5 and 6, the fuel-supply-port-side-pipe contact face 34 is provided along, specifically in parallel to the arrangement direction of the longitudinal-direction arrangement portion 26 of the fuel-supply-port-side pipe 22 which contacts the fuel-supply-port-side-pipe contact face 34. More specifically, the fuel-supply-port-side-pipe contact face 34 is provided along the direction which matches the thickness direction t over a whole length, in the thickness direction t, of the spacer member 31 except the escape portion 34a. Meanwhile, the longitudinal-direction arrangement portion 26 horizontally arranged as described above is also provided along the direction which matches the thickness direction t of the spacer member 31 such that it crosses the fuel-supply-port-side-pipe contact face 34.

Thereby, the fuel-supply-port-side-pipe contact face 34 is parallel to the arrangement direction of the longitudinal-direction arrangement portion 26, and while the longitudinal-direction arrangement portion 26 of the fuel-supply-port-side pipe 22 which is pushed toward the bent portion 11 by the tank-side pipe 21 contacts the fuel-supply-port-side-pipe contact face 34 when the fuel-supply-port-side pipe 22 and the tank-side pipe 21 are connected, the fuel-supply-port-side-pipe contact face 34 can receive the longitudinal-direction arrangement portion 26 at a whole part, in the thickness direction t, thereof.

Further, as shown in FIG. 4, in the state where the spacer member 31 is disposed between the bent portion 11 and the fuel-supply-port-side pipe 22, the bent-portion contact face 33 and the fuel-supply-port-side-pipe contact face 34 are arranged such that a circular orbit X33 along the bent-portion contact face 33 and a circular orbit X34 along the fuel-supply-port-side-pipe contact face 34 are arranged on the same face, and also the circular orbit X34 along the fuel-supply-port-side-pipe contact face 34 is configured to be inscribed in the circular orbit X33 along the bent portion 33 at a position (a lower-right side position) which is located on the side of the longitudinal-direction arrangement portion 26 of the fuel-supply-port-side pipe 22 relative to the spacer member 31 (i.e., at a position which is closer to the longitudinal-direction arrangement portion 26 of the fuel-supply-port-side pipe 22 than the spacer member 31) (see a contact point Pa in FIG. 4).

The band attachment portion 35 is provided adjacently to an upper portion of the fuel-supply-port-side-pipe contact face 34 of the spacer member 31, and is formed in a recess shape at a right face of an upper portion of the spacer member 31 so that a band portion of the fastening band 32 bounding around the bent portion 11 can fit in the recess-shaped portion in a state where the spacer member 31 contacts the bent-portion contact face 33. As shown in FIGS. 5 and 6, the band attachment portion 35 is formed over the whole length, in the thickness direction t, of the right face of the upper portion of the spacer member 31.

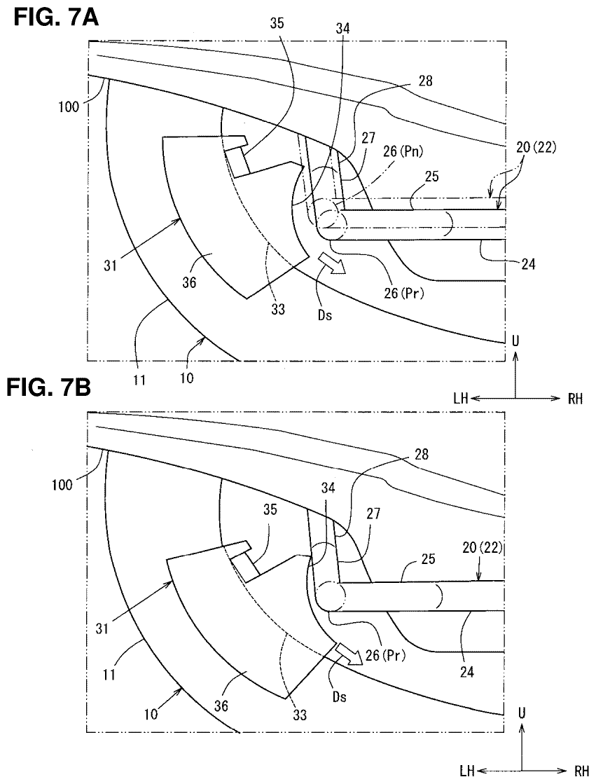

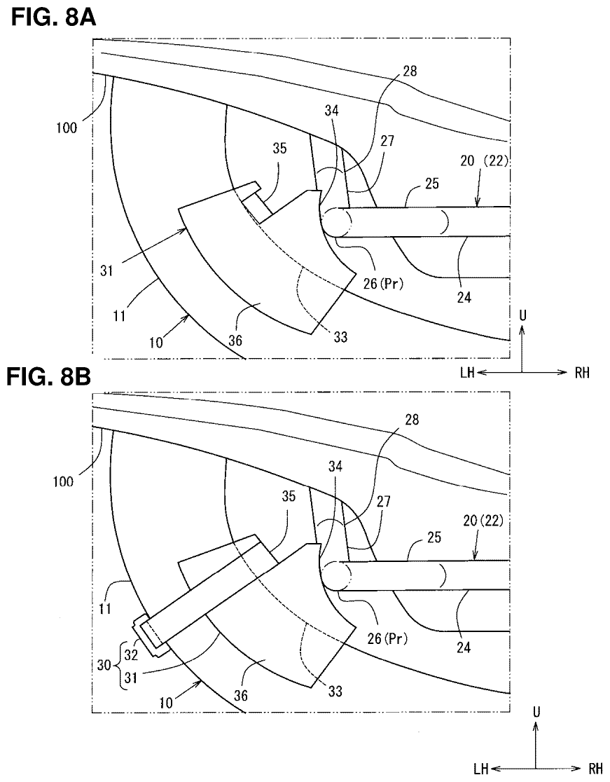

Next, an embodiment of a support method of supporting the recirculation pipe 20 at the bent portion 11 of the fuel pipe 10 via the spacer 30 will be described referring to FIGS. 7A, 7B and 8A, 8B. Herein, the position of the longitudinal-direction arrangement portion 26 is offset from the nominal position Pn toward a lower right side as shown in FIG. 7A.

The support method of the recirculation pipe 20 of the present embodiment is a work (operation) which is conducted before connecting the tank-side pipe 21 and the fuel-supply-port-side pipe 22 of the recirculation pipe 20 when the recirculation pipe 20 is assembled to the vehicle body. This support method comprises a spacer-arrangement step, a spacer-position-specification step, and a spacer-fixation step.

In the spacer-arrangement step, as shown in FIG. 7A, a worker (operator) sets the spacer member 31 in the vicinity of an inner-angle side (diameter inner side) of the bent portion 11, i.e., in an area between the bent portion 11 and the fuel-supply-port-side pipe 22, so that it can be pushed toward the bent portion 11 by the tank-side pipe 21 when the fuel-supply-port-side pipe 22 and the tank-side pipe 21 are connected. In this stage, the bent-portion contact face 33 is made to contact the bent portion 11.

In the subsequent spacer-position-specification step, as shown in FIG. 7B, the worker slides the spacer member 31 from a state shown in FIG. 7A to the side of the longitudinal-direction arrangement portion 26 along the bent portion 11 (see an arrow Ds in FIGS. 7A and 7B). Herein, the bent-portion contact face portion 33 is guided by the pair of side wall portions 36 so that its position does not change in the thickness direction relative to the bent portion 11. Thereby, the spacer member 31 slides smoothly along the bent portion 11. Then, as shown in FIG. 8A, the position of the spacer member 31 is decided in a state where the fuel-supply-port-side-pipe contact face 34 comes to contact the longitudinal-direction arrangement portion 26 and consequently contacts both the bent portion 11 and the longitudinal-direction arrangement portion 26.

In the next spacer-fixation step, as shown in FIG. 8B, the worker attaches the spacer member 31 positioned in the above-described spacer-position-specification step to the bent portion 11 by the fastening band 32. Specifically, the worker wraps the band portion of the fastening band 32 around the spacer member 31 together with the bent portion 11 at the band attachment portion 35 of the spacer member 31 and then makes the band portion of the fastening band 32 engage with a lock portion of the fastening band 32. Thus, the spacer member 31 can be fixed with a specified fastening force in a state where the spacer 31 contacts the bent portion 11 and the longitudinal-direction arrangement portion 26. Herein, since the band attachment portion 35 is provided at the upper portion of the spacer member 31, the worker can easily make access to the fastening band 32 from the outward side, in the vehicle width direction, of the bent portion 11 of the fuel pipe 10, thereby conducting the above-described spacer-fixation step easily.

Even in a case where the position of the longitudinal-direction arrangement portion 26 varies toward the other location than the lower right side, the fuel pipe 10 can be attached, in the same manner as the above-described support method of the recirculation pipe 20, in a state where the spacer member 31 is made to properly contact the bent portion 11 and the longitudinal-direction arrangement portion 26.

Thereby, the spacer member 31 can support the longitudinal-direction arrangement portion 26 in the pushing direction Da properly. That is, after the spacer member 31 is fixed to the bent portion 11 of the fuel pipe 10 by the fastening band 32 as described above, even if the longitudinal-direction arrangement portion 26 of the fuel-supply-port-side pipe 22 is pushed toward the bent portion 11 when the fuel-supply-port-side pipe 22 and the tank-side pipe 21 are connected, the longitudinal-direction arrangement portion 26 can be supported properly via the spacer member 31 at the bent portion 11, so that the rattling of the fuel-supply-port-side pipe 22 can be suppressed.

As shown in FIG. 1, the support structure 1 of the recirculation pipe 20 of the present embodiment comprises the fuel pipe 10 connecting the inside of the fuel tank 2 and the fuel supply port 3 and including the bent portion 11 and the recirculation pipe 20 connecting the upper space of the inside of the fuel tank 2 and the side of the fuel-supply port 3 of the fuel pipe 10. Further, as shown in FIGS. 1-4, the recirculation pipe 20 is configured such that the tank-side pipe 21 which is located on the side of the fuel tank 2 (i.e., located at the position which is closer to the fuel tank 2) and the fuel-supply-port-side pipe 22 which is located on the side of the fuel-supply port 3 (i.e., located at the position which is closer to the fuel-supply port 3) are connectable.

Further, the fuel-supply-port-side pipe 22 is arranged in the inner-angle-side vicinity area Rin of the bent portion 11 such that the fuel-supply-port-side pipe 22 is pushed toward the bent portion 11 by the tank-side pipe 21 when the tank-side pipe 21 and the fuel-supply-port-side pipe 22 are connected, and the spacer 30 is provided between the bent portion 11 and the fuel-supply-port-side pipe 22 in a state where the spacer 30 contacts the bent portion 11 and the fuel-supply-port-side pipe 22, respectively. The spacer 30 includes the fuel-supply-port-side-pipe contact face 34 which is curved in the recess shape relative to the fuel-supply-port-side pipe 22 such that the pushed fuel-supply-port-side pipe 22 is contactable.

According to the above-described structure, the workability of connecting the tank-side pipe 21 and the fuel-supply-port-side pipe 22 can be improved and also the load applied to the fuel-supply-port-side pipe 22 can be suppressed as much as possible.

Specifically, the gap between the recirculation pipe 20 and the bent portion 11 of the fuel pipe 10 tends to vary in the vehicle assembling when the tank-side pipe 10 and the fuel-supply-port-side pipe 22 are connected in the structure in which the fuel-supply-port-side pipe 22 is arranged at the position where the fuel-supply-port-side pipe 22 is pushed toward the bent portion 11 by the tank-side pipe 21. That is, the gap between the longitudinal-direction arrangement portion 26 of the recirculation pipe 20 and the bent portion 11 of the fuel pipe 10 tends to vary.

Even in this case, the position of the spacer 30 can be specified along the bent portion 11 so that the fuel-supply-port-side-pipe contact face 34 can be made to properly contact the fuel-supply-port-side pipe 22 of the recirculation pipe 20. Thereby, the curved-shaped fuel-supply-port-side-pipe contact face 34 can be made to contact the fuel-supply-port-side pipe 22 properly.

Accordingly, while the gap between the recirculation pipe 20 and the bent portion 11 of the fuel pipe 10 tends to vary, the recirculation pipe 20 can be properly supported at the bent portion 11 via the spacer 30 without receiving any load application.

Further, when the tank-side pipe 21 and the fuel-supply-port-side pipe 22 of the recirculation pipe 20 are connected, since the fuel-supply-port-side pipe 22 is supported by the spacer 30 as described above even if the connection end portion of the tank-side pipe 21 is pushed to the connection end portion of the fuel-supply-port-side pipe 22, the rattling during the connection to the tank-side pipe 21 can be suppressed and also the load application can be suppressed.

In the embodiment of the present invention, as shown in FIGS. 2 and 3, the fuel-supply-port-side-pipe contact face 34 is configured to be parallel to the arrangement direction of the longitudinal-direction arrangement portion 26 of the fuel-supply-port-side pipe 22 which contacts the fuel-supply-port-side-pipe contact face 34.

According to this embodiment, even if the longitudinal-direction arrangement portion 26 of the fuel-supply-port-side pipe 22 is pushed toward the bent portion 11 by the tank-side pipe 21 when the fuel-supply-port-side pipe 22 and the tank-side pipe 21 are connected, the longitudinal-direction arrangement portion 26 can be made to properly contact the fuel-supply-port-side-pipe contact face 34 along the arrangement direction. Thereby, the fuel-supply-port-side-pipe contact face 34 can support the longitudinal-direction arrangement portion 26 stably.

In the embodiment of the present invention, as shown in FIG. 4, the fuel-supply-port-side-pipe contact face 34 is configured to have the curvature R34 which is smaller than the curvature R33 of the bent-portion contact face 33, i.e., the curvature R11 of the bent portion 11.

According to this structure, the spacer member 31 can be formed in a wedge shape such that the vertical distance between the bent-portion contact face 33 and the fuel-supply-port-side-pipe contact face 34 is narrower as it goes close to the lower-right side and it enters into the gap between the bent-portion contact face 33 and the fuel-supply-port-side pipe 22. Thereby, the spacer member 31 can be made to contact the bent portion 11 and the fuel-supply-port-side pipe 22 properly by using the wedge effect of the spacer member 31 when the spacer member 31 is made to be close to the side of the fuel-supply-port-side pipe 22 along the bent portion 11.

Accordingly, when the tank-side pipe 21 and the fuel-supply-port-side pipe 22 are connected, the fuel-supply-port-side pipe 22 pushed toward the bent portion 11 contacts the spacer member 31, so that the fuel-supply-port-side pipe 22 can be properly supported at the bent portion 11 via the spacer member 31.

In the embodiment of the present invention, as shown in FIG. 4, the circular orbit X34 along the fuel-supply-port-side-pipe contact face 34 is configured to be inscribed in the circular orbit X33 along the bent-portion contact face 33 at the position which is located on the side of the fuel-supply-port-side pipe 22 relative to the spacer member 31 (see the contact point Pa in FIG. 4).

According to this structure, since the above-described wedge shape can be obtained such that the spacer 30 goes into the gap between the bent-portion contact face 33 and the fuel-supply-port-side pipe 22 further, the spacer 30 can be made to contact both the bent portion 11 and the fuel-supply-port-side pipe 22 securely when the spacer 30 is made to be close to the side of the fuel-supply-port-side pipe 22 along the bent portion 11.

In the embodiment of the present invention, as shown in FIGS. 1-4, the fastening band 32 as the fixation member to fix the upper-side portion of the spacer member 31 to the bent portion 11 is provided at the portion of the spacer member 31 which is positioned at the upper side relative to the fuel-supply-port-side-pipe contact face 34.

According to this structure, when the tank-side pipe 21 and the fuel-supply-port-side pipe 22 are connected, the spacer 30 can be fixed to the bent portion 11 so that the fuel-supply-port-side pipe 22 does not rattle as the tank-side pipe 21 is pushed toward the fuel-supply-port-side pipe 22.

In correspondence of the present invention to the above-described embodiment, the tank of the present invention corresponds to the fuel tank 2 of the embodiment. Likewise, the vicinity of the bent portion 11 corresponds to the inner-angle-side vicinity area Rin of the bent portion 11, the fixation member corresponds to the fastening band 32, the curvature R11 of the bent portion corresponds to the curvature R33 of the bent-portion contact face 33, any one side of the spacer corresponds to the upper side of the spacer member 31, and the circular orbit along the bent portion corresponds to the circular orbit X33 along the bent-portion contact face 33. However, the present invention is not to be limited to the above-described embodiment, and any modifications are applicable.

For example, there may be provided the fastening band 32 as the fixation member to spacer member 31 to the bent portion 11 at the lower-side portion of the fuel-supply-port-side-pipe contact face 34 or both the upper-side portion and the lower-side portion of this contact face 34, illustration of which is omitted here.

The fixation member of the present invention is not limited to the fastening band 32 as long as the spacer member 31 can be fixed to the bent portion 11. For example, the double-sided tape, the face fastener, the string-shaped member, the fastening member, the adhesive, or any combined-structure are usable. Further, while it is preferable that the spacer of the present invention comprise the fixation member, it is not indispensable and this fixation member may not be provided as long as the fuel-supply-port-side pipe can be supported on the side of the bent portion.

What is claimed is:

1. A support structure of a recirculation pipe, comprising:
a fuel pipe connecting an inside of a tank and a fuel-supply port and including a bent portion; and
a recirculation pipe connecting an upper space of the inside of the tank and a side of the fuel-supply port of the fuel pipe, the recirculation pipe being configured such that a tank-side pipe thereof which is located on a side of the tank and a fuel-supply-port-side pipe thereof which is located on a side of the fuel-supply port are connectable,
wherein said fuel-supply-port-side pipe of the recirculation pipe is arranged in the vicinity of said bent portion of the fuel pipe such that the fuel-supply-port-side pipe is pushed toward the bent portion by said tank-side pipe when the tank-side pipe and the fuel-supply-port-side pipe are connected, and a spacer is provided between said bent portion of the fuel pipe and said fuel-supply-port-side pipe of the recirculation pipe in a state where the spacer contacts the bent portion and the fuel-supply-port-side pipe, respectively, the spacer including a fuel-supply-port-side-pipe contact face which is curved in a recess shape relative to the fuel-supply-port-side pipe such that the pushed fuel-supply-port-side pipe is contactable.

2. The support structure of the recirculation pipe of claim 1, wherein said fuel-supply-port-side-pipe contact face of the spacer is configured to be parallel to an arrangement direction of said fuel-supply-port-side pipe of the recirculation pipe which contacts the fuel-supply-port-side-pipe contact face.

3. The support structure of the recirculation pipe of claim 1, wherein said fuel-supply-port-side-pipe contact face of the spacer is configured to have a smaller curvature than said bent portion of the fuel pipe.

4. The support structure of the recirculation pipe of claim 3, wherein a circular orbit along said fuel-supply-port-side-pipe contact face of the spacer is configured to be inscribed in a circular orbit along said bent portion at a position which is located on a side of said fuel-supply-port-side pipe relative to said spacer.

5. The support structure of the recirculation pipe of claim 1, wherein a fixation member to fix said spacer to said bent portion of the fuel pipe is provided at a portion of the spacer which is positioned at any one side, in a direction along said bent portion, of the spacer relative to said fuel-supply-port-side-pipe contact face.

6. The support structure of the recirculation pipe of claim 2, wherein said fuel-supply-port-side-pipe contact face of the spacer is configured to have a smaller curvature than said bent portion of the fuel pipe.

7. The support structure of the recirculation pipe of claim 2, wherein a fixation member to fix said spacer to said bent portion of the fuel pipe is provided at a portion of the spacer which is positioned at any one side, in a direction along said bent portion, of the spacer relative to said fuel-supply-port-side-pipe contact face.

8. The support structure of the recirculation pipe of claim 3, wherein a fixation member to fix said spacer to said bent portion of the fuel pipe is provided at a portion of the spacer which is positioned at any one side, in a direction along said bent portion, of the spacer relative to said fuel-supply-port-side-pipe contact face.

9. The support structure of the recirculation pipe of claim 4, wherein a fixation member to fix said spacer to said bent portion of the fuel pipe is provided at a portion of the spacer which is positioned at any one side, in a direction along said bent portion, of the spacer relative to said fuel-supply-port-side-pipe contact face.

10. A support method of a recirculation pipe which comprises a fuel pipe connecting an inside of a tank and a fuel-supply port and including a bent portion, a recirculation pipe connecting an upper space of the inside of the tank and a side of the fuel-supply port of the fuel pipe, the recirculation pipe being configured such that a tank-side pipe thereof which is located on a side of the tank and a fuel-supply-port-side pipe thereof which is located on a side of the fuel-supply port are connectable, and a spacer including a fuel-supply-port-side-pipe contact face which contacts said fuel-supply-port-side pipe of the recirculation pipe in a connection state of said tank-side pipe and the fuel-supply-port-side pipe, wherein said fuel-supply-port-side pipe which is pushed toward said bent portion of the fuel pipe by said tank-side pipe is configured to be supported by said fuel pipe via said spacer in a case where the tank-side pipe is connected, the support method of the recirculation pipe comprising:
a spacer-arrangement step of arranging said spacer between said bent portion of the fuel pipe and said fuel-supply-port-side pipe of the recirculation pipe in a state where the spacer contacts the bent portion;
a spacer-position-specification step of sliding the spacer along the bent portion to a position where said fuel-supply-port-side-pipe contact face of the spacer comes to contact the fuel-supply-port-side pipe; and
a spacer-fixation step of fixing the spacer at the position specified in the spacer-position-specification step.
